(19) United States
(12) Patent Application Publication
(10) Pub. No.: US 2017/0071034 A1
(43) Pub. Date: Mar. 9, 2017

(54) INDUCTION HOLDING, WARMING, AND COOKING SYSTEM HAVING IN-UNIT MAGNETIC CONTROL

(71) Applicant: CookTek Induction Systems, LLC, Chicago, IL (US)

(72) Inventor: Reinhard Metz, Wheaton, IL (US)

(21) Appl. No.: 14/849,022

(22) Filed: Sep. 9, 2015

(51) Int. Cl. H05B 6/06; H05B 6/12

(52) U.S. Cl. CPC H05B 6/062; H05B 6/1209

(57) ABSTRACT

An induction-based food holding, warming, or cooking system. The system including a base having a based surface associated therewith. The system further including an induction coil disposed within the base adjacent the base surface, wherein the portion of the base surface adjacent the coil comprises a base surface. The system further including a user interface associated with the base surface, the user interface including at least one magnetic sensor for receiving a user input from a magnetic user input device.

### BACKGROUND

The present invention generally relates to holding, warming, and cooking systems, such as but not limited to stoves, ranges, cooktops, cooking plates, holding and warming units, ovens, broilers, grills, microwave ovens, and griddles. More specifically, the present invention generally relates to induction holding, warming, and cooking systems, such as but not limited to the control of induction-based holding, warming, and cooking systems.

Typically, induction holding and warming systems and, to some extent, cooking systems, include an external control unit which is separately mounted from the induction holding, warming, or cooking system. Such a configuration may increase installation costs as well as material costs, and add possible failure modes.

### SUMMARY

In one embodiment, the invention provides an induction-based food holding, warming, or cooking system. The system includes a base having a based surface associated therewith. The system further includes an induction coil disposed within the base adjacent the base surface, wherein the portion of the base surface adjacent the coil comprises a base surface. The system further includes a user interface associated with the base surface, the user interface including at least one magnetic sensor for receiving a user input from a magnetic user input device.

In another embodiment, the invention provides an induction-based food holding/warming system. The system includes a base having a base surface associated therewith, the base being disposed at the bottom of a well. The system further includes an induction coil disposed within the base adjacent the base surface, wherein the portion of the base surface adjacent the coil comprises a base surface. The system further includes a user interface associated with the base surface, wherein the user interface permits adjustment of the food holding/warming system using a contactless input device.

Other aspects of the invention will become apparent by consideration of the detailed description and accompanying drawings.

### BRIEF DESCRIPTION OF THE DRAWINGS

FIG. 1 is a perspective view of an induction holding and warming system according to one embodiment of the invention.

FIG. 2 is a perspective view of the holding and warming system of FIG. 1 receiving a vessel.

FIG. 3 is a top view of an embodiment of the holding and warming system of FIG. 1.

FIG. 4 is a block diagram of an embodiment of a holding and warming system of FIG. 1 including a controller.

FIG. 5 is an enlarged schematic of a user interface of an embodiment of the holding and warming system of FIG. 1.

FIG. 6 is a cross-sectional functional view of an embodiment of the holding and warming system of FIG. 1.

FIG. 7 is a perspective view of a user input device used with an embodiment of the holding and warming system of FIG. 1.

FIG. 8 is a flowchart illustrating an operation of an embodiment of the holding and warming system of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

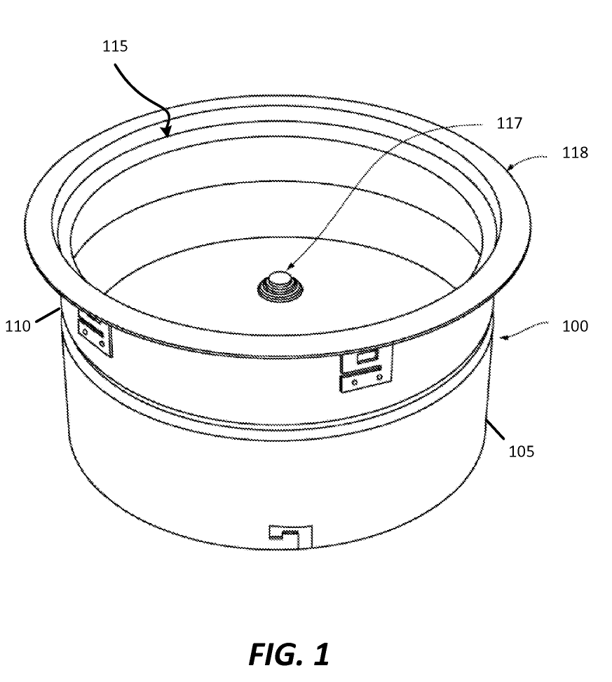

FIG. 1 is a perspective view of a holding and warming system 100 according to one embodiment of the present invention. The system 100 includes a system base 105 and one or more side walls 110 defining a well 115. Although illustrated as a cylinder, the system 100 may be a variety of shapes, including but not limited to, a circle, a rectangle, or a square. Additionally, in some embodiments, the system 100 may be a cooktop installed within a surface such as, but not limited to, a kitchen counter or a warming table on a serving line.

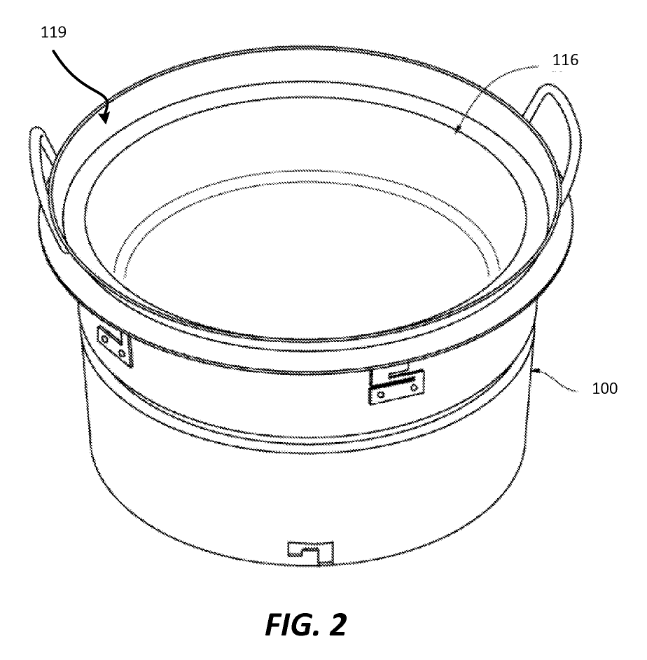

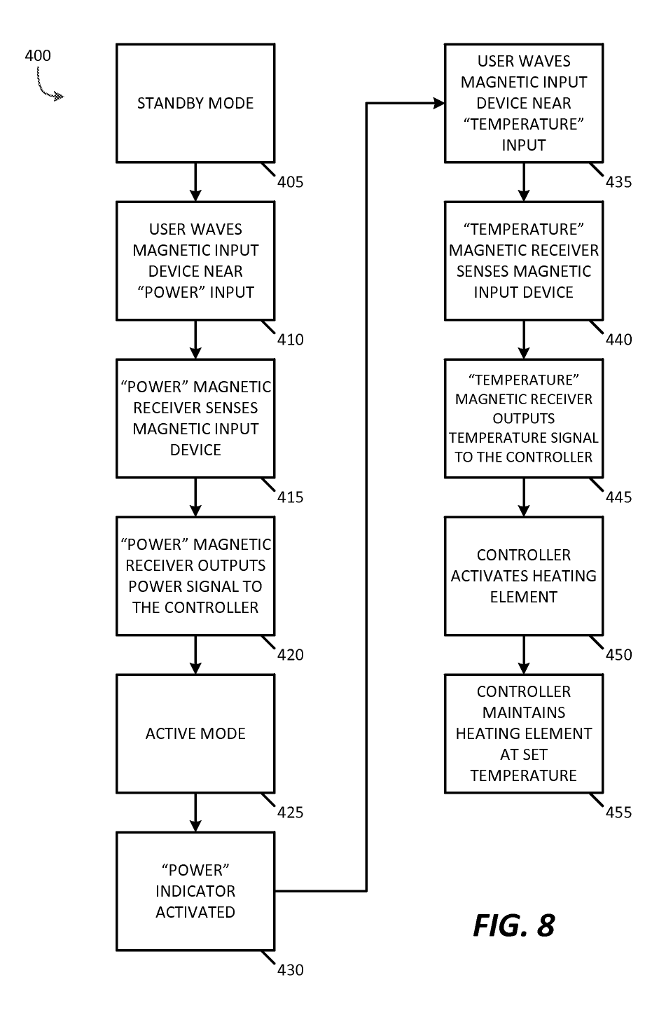

The well 115 is configured to receive a vessel 116 for holding or warming, or cooking food such as, but not limited to, a pot or pan including, e.g., a hotel pan (FIG. 8). In some embodiments, the vessel 116 is stainless steel. In such an embodiment, the pot or pan may be made substantially of 300-series stainless steel (which has very low magnetic permeability). In other embodiments, the pot or pan is made of a ferromagnetic material such as iron or grades of steel (e.g. 400-series stainless steel) that are ferromagnetic. In some embodiments, such as illustrated in FIG. 1, the holding and warming system 100 further includes a temperature sensor 117 and a lip 118. The temperature sensor 117 is configured to sense a temperature of the vessel 116. The lip 118 is configured to align and hold the vessel 116 (FIG. 2).

FIG. 2 is a perspective view of the system 100 receiving the vessel 116. The vessels 116 generally have a rim 119 around the top which protrudes from the edge of the vessel 116 and which rests on the top edge of the well 115, so that the weight of the pans are supported by the rims of the pans rather than the bottom of the pan.

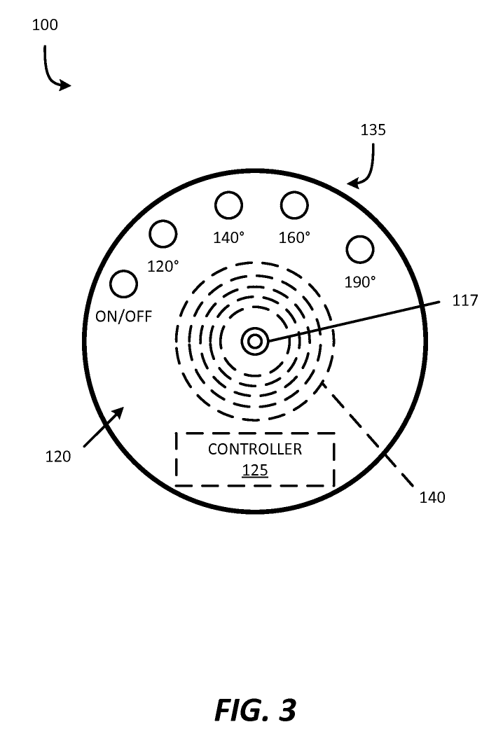

FIG. 3 is a top view of an embodiment of the system 100, which in one particular embodiment is an induction-based system for food holding and warming. The induction system 100 further includes a base surface 120; a controller 125; the temperature sensor 117; and a user interface 135. The induction system 100 also includes a heating element 140 (FIG. 3), such as, but not limited to, a magnetic coil located adjacent (e.g. beneath) the base surface 120 within the base 105. The base surface 120 provides a barrier between the heating element 140 and the vessel 116 to be heated.

The user interface 135 is associated with the base surface 120 and, in various embodiments, the user interface 135 may be located in a region of the base surface 120 such that the user interface 135 is adjacent the coil but not overlapping with the coil, or the user interface 135 may overlap with the coil. The coil is configured to produce an oscillating magnetic field operating at, e.g. 20 to 30 kHz. In operation, the oscillating magnetic field induces a current in a vessel 116 placed on the base surface 120. The oscillating magnetic field heats the material of the vessel 116 by generating small eddy currents within the material and by causing oscillation of magnetic dipoles within the material. The heat produced is proportional to the induced current.

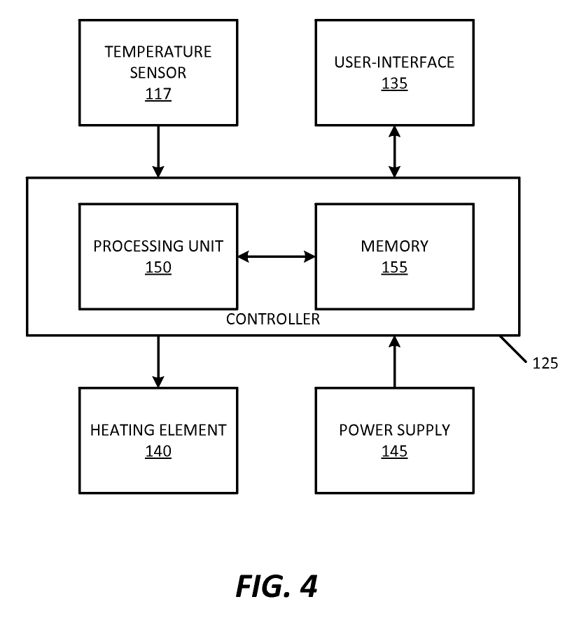

FIG. 4 is a block diagram of an embodiment of the system 100 including controller 125. The controller 125 may be communicatively (e.g. electrically) connected to a variety of modules or components of the system 100. For example, in various embodiments the illustrated controller 125 is connected to one or more of: the temperature sensor 117, the user interface 135, the heating element 140, and a power supply 145. The controller 125 includes combinations of hardware and software that are operable to, among other things, control the operation of the system 100.

In some embodiments, the controller 125 includes a plurality of electrical and electronic components that provide power, operational control, and protection to the components and modules within the controller 125 and/or the system 100. For example, the controller 125 includes, among other things, a processing unit 150 (e.g., a microprocessor, a microcontroller, or another suitable programmable device) and a memory 155. The processing unit 150 and the memory 155, as well as the various modules connected to the controller 125, are connected by one or more control and/or data buses. The control and/or data buses are shown generally in FIG. 3 for illustrative purposes. The use of one or more control and/or data buses for the interconnection between and communication among the various modules and components would be known to a person skilled in the art in view of the invention described herein. In some embodiments, the controller 125 is implemented partially or entirely on a semiconductor (e.g., a field-programmable gate array [FPGA] semiconductor) chip, such as a chip developed through a register transfer level (RTL) design process.

The memory 155 includes, for example, a program storage area and a data storage area. The program storage area and the data storage area can include combinations of different types of memory, such as read-only memory (ROM), random access memory (RAM) (e.g., dynamic RAM [DRAM], synchronous DRAM [SDRAM], etc.), electrically erasable programmable read-only memory (EEPROM), flash memory, a hard disk, an SD card, or other suitable magnetic, optical, physical, or electronic memory devices. The processing unit 150 is connected to the memory 155 and executes software instructions that are capable of being stored in a RAM of the memory 155 (e.g., during execution), a ROM of the memory 155 (e.g., on a generally permanent basis), or another non-transitory computer readable medium such as another memory or a disc. Software included in the implementation of the system 100 can be stored in the memory 155 of the controller 125. The software includes, for example, firmware, one or more applications, program data, filters, rules, one or more program modules, and other executable instructions. The controller 125 is configured to retrieve from memory and execute, among other things, instructions related to the control processes and methods described herein. In other constructions, the controller 125 includes additional, fewer, or different components.

The power supply 145 supplies a nominal AC or DC voltage to the controller 125 or other components or modules of the system 100 (e.g., the user interface 135, the heating element 140, etc.). The power supply 145 is powered by, for example, a power source having nominal line voltages between 100V and 240V AC and frequencies of approximately 50-60 Hz. The power supply 145 is also configured to supply lower voltages to operate circuits and components within the controller 125 or the system 100.

The temperature sensor 117 senses the temperature of the vessel 116 placed on or near the base surface 120. The temperature sensor 117 may be, but is not limited to, a thermistor, a thermocouple, a resistance thermometer, and a silicon bandgap temperature sensor. The temperature sensor 117 senses the temperature of the vessel 116 and communicates the sensed temperature to the controller 125. In some embodiments, infrared temperature sensing may be combined with, or substituted for, direct contact sensing (e.g. using an RTD or other temperature sensors as described above) to provide more accurate temperature readings. Infrared sensing may be conducted through a window of infrared-transmitting material in the base surface 120, generally within region of the base surface 120. Further details of temperature sensing systems and methods are disclosed in U.S. patent application Ser. No. 14/745,960 filed Jun. 22, 2015 (Atty. Ref. 206855-9001-US01), which is incorporated herein by reference in its entirety.

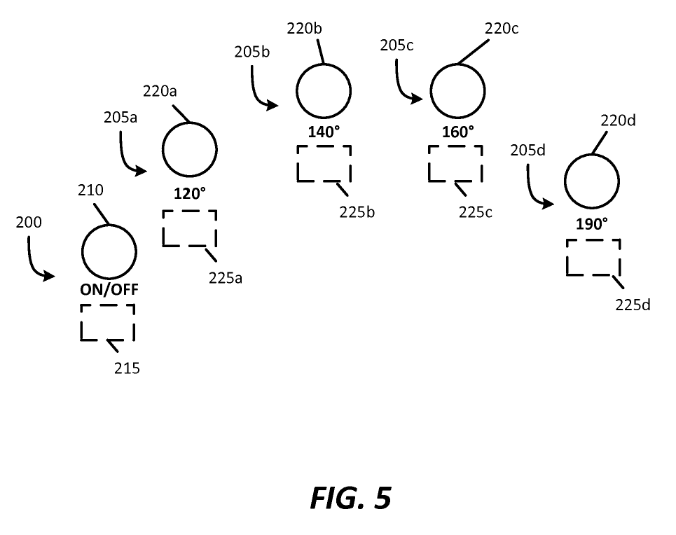

FIG. 5 is an enlarged view of a portion of FIG. 2 illustrating the user interface 135. The user interface 135 receives user input from a user and communicates the user input to the controller 125 in order to control the system 100 accordingly. In the illustrated embodiment, the user interface 135 includes a POWER input 200 and a plurality of TEMPERATURE inputs 205a-205d. In the illustrated embodiment, the plurality of TEMPERATURE inputs 205a-205d correspond to temperature settings of 120° F., 140° F., 160° F., and 190° F. respectively; however, in other embodiments, the plurality of TEMPERATURE inputs 205a-205d may correspond to a variety of other temperatures. Additionally, in other embodiments, the user interface 135 may include fewer or more inputs and may include inputs for setting parameters other than, or in addition to, temperature, such as timers (e.g. for automatically shutting off the system) and power levels and for controlling features such as lockout (e.g. to prevent tampering with controls).

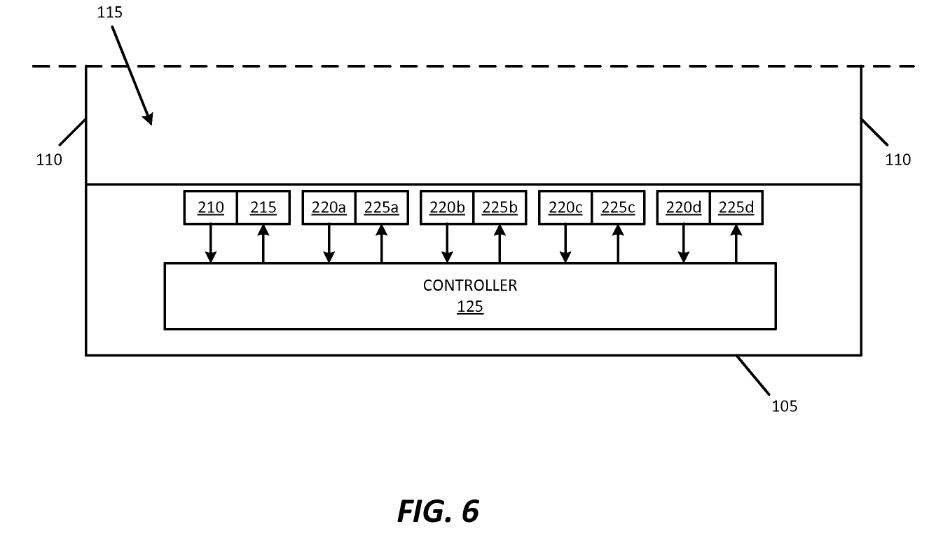

FIG. 6 is a cross-sectional view of the system 100. As illustrated, the POWER input 200 includes a POWER indicator 210 and a POWER magnetic receiver 215. Additionally, each TEMPERATURE input 205a-205d includes a TEMPERATURE indicator 220a-220d and a respective TEMPERATURE magnetic receiver 225a-225d. The POWER indicator 210 and the TEMPERATURE indicators 220a-220d provide indications to the user of the current state of the respective setting, e.g. whether the power is on or off and which temperature is currently selected. The input-receiving components of the user interface 135 such as the POWER magnetic receiver 215 and the TEMPERATURE magnetic receivers 225a-225d receive input from the user. In some embodiments, the POWER indicator 210 and the TEMPERATURE indicators 220a-220d are light-emitting diodes (LEDs) or another type of light. In some embodiments, the POWER magnetic receiver 215 and the TEMPERATURE magnetic receivers 225a-225d are magnetic sensors such as, but not limited to, Hall-effect sensors, magnetic reed switch, or the like. Although described as magnetic sensors, in other embodiments, the POWER magnetic receiver 215 and the TEMPERATURE magnetic receivers 225a-225d may include one or more other types of sensors, in addition to or in lieu of, the magnetic sensors. For example, in one embodiment, the POWER magnetic receiver 215 and the TEMPERATURE magnetic receivers 225a-225d are radio frequency identification (RFID) sensors, which may include RFID sensors in addition to, or in lieu of, magnetic sensors. In various embodiments the indicators 210, 220a-220d and magnetic receivers 215, 225a-225d may be disposed so that they are flush with the bottom of the well 115 (FIG. 5) or they may protrude from the bottom surface of the well 115 (FIG. 8). In either arrangement, in certain embodiments the bottom of the well 115 and any components installed therein are made to be fluid-tight so that liquids such as food and water that may contact the bottom of the well 115 (e.g. due to accidental spillage) do not permeate the base 105. As discussed further below, a user passes a magnetic input device 300 (e.g. containing a contactless component such as a magnet and/or RFID tag) near one or more magnetic receivers, such that the targeted magnetic receiver detects the presence of the magnetic input device 300 (e.g. magnetically or through short-range radio communication) and produces an appropriate response (e.g. a signal to the controller to an operational function) depending on which magnetic receiver is activated and the current state of the magnetic receiver.

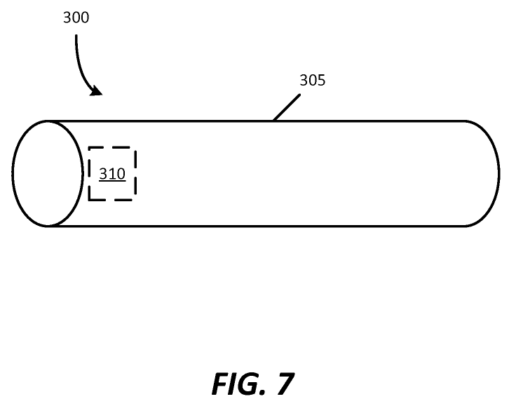

FIG. 7 is a perspective view of a magnetic input device 300. The magnetic input device 300 may be used by a user to provide contactless user input to the user interface 135. In the illustrated embodiment, the magnetic input device 300 is a wand having a base 305 and a receiver activation portion 310. The base 305 is held by the user. The receiver activation portion 310 interacts (generally in a contactless, or touch-free, manner) with at least one of the magnetic receivers 215, 225a-225d. In some embodiments, the receiver activation portion 310 includes a magnet. However, in other embodiments, the receiver activation portion 310 may include in addition to the magnet, or in lieu of the magnet, another component operable to be detected by the magnetic receivers 215, 225a-225d. For example, in other embodiments, the receiver activation portion 310 is a radio frequency identification (RFID) tag, where the use of an RFID tag can provide additional security against tampering with the controls since each device 300 could have a unique identification code. In other embodiments, the magnetic input device 300 may be a variety of other shapes and sizes including, but not limited to, a key fob or card. In certain embodiments in which the receiver activation portion 310 is a magnet, the magnetic receivers 215, 225a-225d detect the magnetic field emitted by the magnetic input device 300 using, e.g., a Hall effect sensor. In other embodiments in which the receiver activation portion 310 is an RFID tag, the magnetic receivers 215, 225a-225d detect the magnetic field emitted by the magnetic input device 300 using, e.g., an RFID reader. In still other embodiments, the receiver activation portion 310 includes an optically-readable pattern such as a barcode or QR code (e.g. applied to the magnetic input device 300 either directly or on a tag or label applied to the device 300) and the magnetic receivers 215, 225a-225d include suitable optical components for scanning and reading the pattern.

FIG. 8 is a flowchart illustrating a process 400, according to one embodiment, of operating the system 100. The system 100 is in standby, or off, mode (Step 405). A user waves the magnetic input device 300 near the POWER input 200 (Step 410). The POWER magnetic receiver 215 of the POWER input 200 senses the receiver activation portion 310 of the magnetic input device 300 (Step 415). The POWER magnetic receiver 215 outputs a power signal to the controller 125 (Step 420). The controller 125 receives the signal and exits out of standby mode into active mode (Step 425). The controller 125 activates the POWER indicator 210 (Step 430). The user passes the magnetic input device 300 near one of the TEMPERATURE inputs 205a-205d (Step 435) to select an operating temperature. The TEMPERATURE magnetic receivers 225a-225d of the corresponding TEMPERATURE inputs 205a-205d sense the receiver activation portion 310 of the magnetic input device 300 (Step 440). The TEMPERATURE magnetic receiver 225a-225d outputs a temperature signal to the controller 125 (Step 445). The controller 125 receives the temperature signal and activates the corresponding temperature indicator 220a-220d (Step 450). The controller 125 activates the heating element 140 to bring the vessel 116 to the temperature selected by the user (Step 450). The controller 125 (e.g. continuously or intermittently) receives temperature readings for the vessel 116 from the temperature sensor 117 and operates the heating element 140 to maintain the temperature selected by the user (Step 455). In some embodiments, the user may wave the magnetic input device 300 near the POWER input 200 or any one of the TEMPERATURE inputs 205a-205d at any time to control the system 100.

Accordingly, the contactless magnetic input device 300 disclosed herein permits a user to control the disclosed system 100 without touching the controls. The lack of direct contact with the controls permits the controls to be placed close to or overlapping with the base surface 120, whereas with other systems which require contact the controls must be located away from the heating area so that the controls remain cool enough to be touched. As a result, the disclosed magnetic input device 300 permits the controls to be integrated into or near the base surface 120, and in some cases completely hidden from view, thereby providing a product with a cleaner, less cluttered appearance. In some embodiments, the disclosed system 100 is an induction-based food holding/warming system in which the vessel 116 includes warming pans which are placed into wells 115 on a serving line; in general the food container/vessel 116 is placed over the controls/user interface 135. As stated above, the vessels 116 generally have a rim 119 around the top which protrudes from the edge of the vessel 116 and which rests on the top edge of the well 115, so that the weight of the pans are supported by the rims of the pans rather than the bottom of the pan. The bottom of the pan is generally located relatively close to the bottom of the well where the heat source (e.g. the induction coil) is disposed. In such embodiments, locating controls inside the well has advantages such as keeping the controls out of view (for better appearance of the system) and preventing customers from tampering with the controls. Locating controls inside the warming wells also makes each unit easier to install, since no external controls need to be provided; instead, other than a power source, each drop-in unit is self-contained. The contactless controls can be operated without a user having to touch (or even get their hands close to) hot surfaces. Finally, the use of contactless controls permits the bottom of the well 115 to be sealed off to prevent damage to the controls and other electronics in the event of food or water spillage into the well 115.

Thus, the invention provides, among other things, an induction holding, warming, and cooking system having in-unit magnetic controls. Various features and advantages of the invention are set forth in the following claims.

What is claimed is:

1. An induction-based food holding, warming, or cooking system, comprising:
a base having a based surface associated therewith;
an induction coil disposed within the base adjacent the base surface, wherein the portion of the base surface adjacent the coil comprises a base surface; and
a user interface associated with the base surface, the user interface including at least one magnetic sensor for receiving a user input from a magnetic user input device.

2. The system of claim 1, wherein the user input is a temperature adjustment.

3. The system of claim 1, wherein the user input is a power control.

4. The system of claim 1, wherein the magnetic sensor is a Hall effect sensor.

5. The system of claim 1, wherein the magnetic sensor is a magnetic reed switch.

6. The system of claim 1, wherein the magnetic user input device includes a magnet.

7. An induction-based food holding, warming, or cooking system, comprising:
a base having a base surface associated therewith;
an induction coil disposed within the base adjacent the base surface, wherein the portion of the base surface adjacent the coil comprises a base surface; and
a user interface associated with the base surface, wherein the user interface permits adjustment of the induction-based food holding, warming, or cooking system using a contactless input device.

8. The system of claim 7, wherein the user interface includes a temperature adjustment control.

9. The system of claim 7, wherein the base is at a bottom of a well.

10. The system of claim 7, wherein the user interface includes a plurality of controls, wherein each control includes an indicator and a receiver.

11. The system of claim 10, wherein the plurality of controls includes at least one of a temperature control and a power control.

12. The system of claim 10, wherein the receiver includes a magnetic sensor which is activated by a change in a magnetic field adjacent the receiver.

13. The system of claim 12, wherein the magnetic sensor is a Hall effect sensor.

14. The system of claim 12, wherein the magnetic sensor is a magnetic reed switch.

15. The system of claim 10, wherein the indicator includes a light.

16. The system of claim 10, wherein the receiver includes an RFID sensor.

17. An induction-based food holding/warming system, comprising:
a base having a base surface associated therewith, the base being disposed at the bottom of a well;
an induction coil disposed within the base adjacent the base surface, wherein the portion of the base surface adjacent the coil comprises a base surface; and
a user interface associated with the base surface, wherein the user interface permits adjustment of the food holding/warming system using a contactless input device.

18. The system of claim 17, wherein the well comprises at least one side having an edge at a top thereof.

19. The system of claim 18, further comprising a vessel having a rim protruding outward from a top portion of the vessel, wherein when the vessel is disposed within the well the rim of the vessel is supported by the top edge of the well.

20. The system of claim 19, further comprising a temperature sensor disposed at the bottom of the well.

21. The system of claim 20, wherein when the vessel is disposed within the well, the temperature sensor contacts an outside surface of the vessel.

22. The system of claim 17, wherein the user interface includes a plurality of controls, wherein each control includes an indicator and a receiver.

23. The system of claim 22, wherein the plurality of controls includes at least one of a temperature control and a power control.

24. The system of claim 20, wherein the receiver includes a magnetic sensor which is activated by a change in a magnetic field adjacent the receiver.

25. The system of claim 24, wherein the magnetic sensor is a Hall effect sensor.

26. The system of claim 24, wherein the magnetic sensor is a magnetic reed switch.

27. The system of claim 24, wherein the contactless input device comprises a magnet for interacting with the magnetic sensor.
